(19) United States
(12) Patent Application Publication
(10) Pub. No.: US 2009/0124194 A1
(43) Pub. Date: May 14, 2009

(54) SYSTEM AND METHOD FOR PLAYING ANIMATED INFORMATION ON A HOST UPON CONNECTION WITH A WIRELESS DEVICE

(75) Inventor: Rahul Chaturvedi, San Diego, CA (US)

Correspondence Address: FOLEY & LARDNER LLP, P.O. BOX 80278, SAN DIEGO, CA, 92138-0278, US

(73) Assignee: Novatel Wireless

(21) Appl. No.: 11/939,488

(22) Filed: Nov. 13, 2007

(51) Int. Cl. H04H 20/71

(52) U.S. Cl. 455/3.06

(57) ABSTRACT

A system and method by which audio clips, video clips and/or combination audio-video clips may be exhibited when a device is connected to a local host. According to various embodiments, one or more A/V clips reside on a device. When the device is operatively connected to a host, the A/V clips are uploaded to the host and are run on the host. A service carrier or provider is therefore capable of providing its own unique branding to the end user in an animated form when a connection is made, or to provide other information to the end user through the use of A/V clips.

### FIELD OF THE INVENTION

The present invention relates generally to the playing of audio and video content. More particularly, the present invention relates to the playing of audio and video content upon the connection of a device with a host.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Wireless Wide Area Network (WWAN) are cellular networks that operate over great distances. WWAN providers or carriers often use proprietary software for purposes of connection management of WWAN data devices. Such connection managers are typically developed by third parties for specific service carriers and are loaded onto host computers (referred to herein simply as “hosts.”) Therefore, all co-branding for the service carrier is typically provided within the connection manager that is being used.

Recently, device vendors have begun to provide skeleton connection managers that are resident on the respective WWAN devices in order to make an initial connection easier. In such arrangements, an end user can decide whether to keep the “easy connect” connection manager client or to update to a carrier-provided connection manager. From the carrier's point of view, it is preferable for the end user to use its own connection manager instead of the manager provided by the device vendor, since the “easy connect” connection manager typically only has static branding (i.e., non-moving images) built into them. Furthermore, although it may be possible to include more animated branding in a connection manager, this would require the downloading of a new connection manager for each end user, resulting in a more cumbersome process.

### SUMMARY OF THE INVENTION

Various embodiments of the present invention provide a system and method by which audio clips, video clips and/or combination audio-video clips (collectively referred to as “A/V clips”) may be exhibited when a device is connected to a local host. According to various embodiments, one or more A/V clips reside on a device and are run on the host upon each end user connection occurring. For example, when a WWAN USB dongle is used, an A/V clip stored on the dongle is automatically uploaded and run on the host, without any actions necessary on the part of the end user. This provides the carrier the opportunity to provide its own unique branding to the end user when a connection is made, or to provide other information to the end user through the use of A/V clips.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a representation of a system showing the interaction between a host device and a WWAN device according to various embodiments of the present invention;

FIG. 2 is a schematic representation of circuitry which may be included in one or more devices involved in the implementation of various embodiments of the present invention; and

FIG. 3 is a flow chart showing the process by which various embodiments of the present invention may be implemented.

### DETAILED DESCRIPTION OF VARIOUS EMBODIMENTS

Various embodiments of the present invention provide a system and method by which audio clips, video clips and/or combination audio-video clips (collectively referred to as “A/V clips”) may be exhibited when a device is connected to a local host. According to various embodiments, one or more A/V clips reside on a device and are run on the host upon each end user connection occurring. For example, when a WWAN USB dongle is used, an A/V clip stored on the dongle is automatically uploaded and run on the host, without any actions necessary on the part of the end user. The playing of such an animation provides a carrier with the ability to present its branding or image in a compelling fashion, or to provide animated advertising or other relevant information to the user. Additionally, using such a system, A/V clips can be updated over-the-air to the device without any changes required at a connection manager.

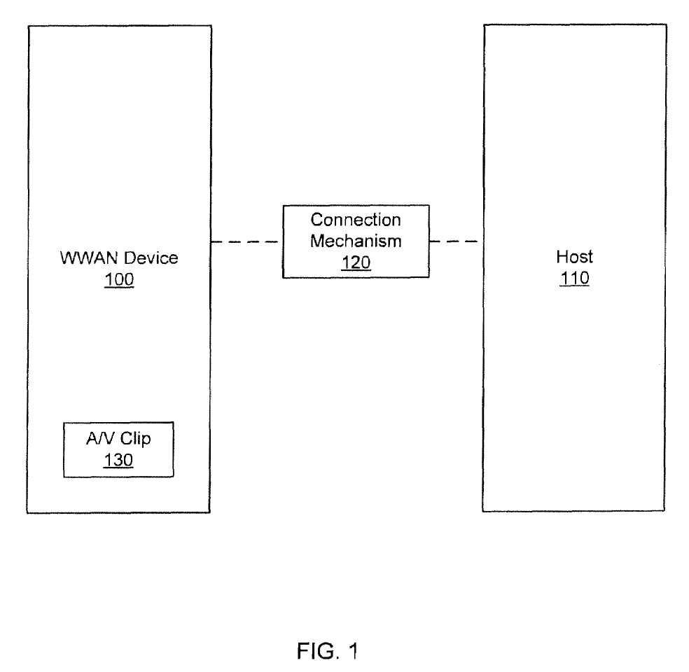

FIG. 1 is a representation of a system showing the interaction between a host device and a WWAN device according to various embodiments of the present invention. As shown in FIG. 1, a WWAN device 100 operatively connects to a host 110 via a connection mechanism 120. The WWAN device 100 may comprise, for example of a WWAN USB dongle, which may be used to authenticate a piece of software on the host 110. The connection mechanism 120 can take a variety of forms. By way of example only, the connection mechanism 120 may comprise a cardbus, an express card, a peripheral component interconnect (PCI) express mini card, a wireless local area network (WLAN) connection, etc. In addition, at least one A/V clip 130 is resident on the WWAN device 100, for example in a memory unit thereof. Each A/V clip 130 may comprise, for example, an audio clip, a video clip or a combination audio/video clip. Each A/V clip 130 may be in one of a variety of file formats known in the art.

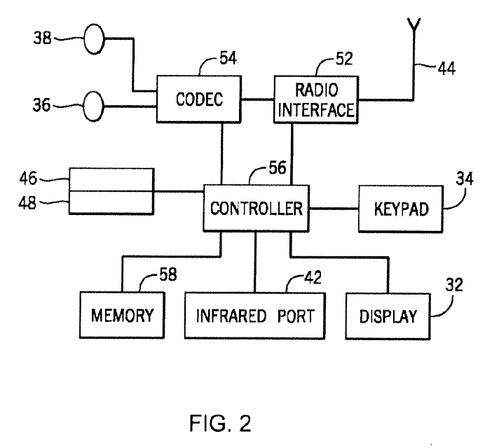

FIG. 2 is a schematic representation of circuitry which may be included in one or more devices (e.g., the WWAN device 100 and/or the host 110) involved in the implementation of various embodiments of the present invention. It should be understood, however, that the various embodiments of the present invention may include many different types of devices. The various electronic device capable of implementing the various embodiments may include features such as a display 32, a keypad 34, a microphone 36, an ear-piece 38, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type known in the art.

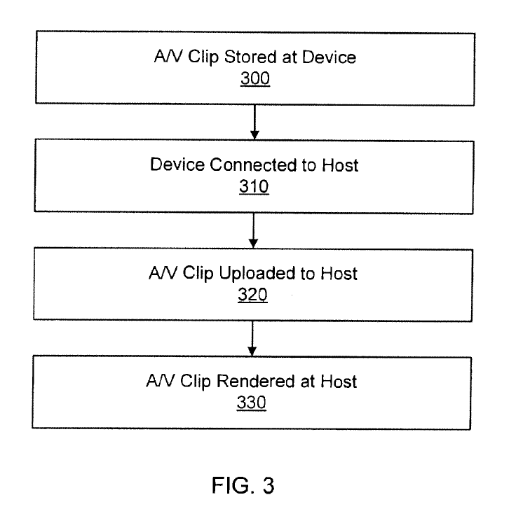

FIG. 3 is a flow chart showing the implementation of various embodiments of the present invention. At 300 in FIG. 3, an A/V clip is stored on a memory of a device such as a WWAN device. As discussed above, A/V clips can be sent or updated over-the-air to the device as necessary or desired by the provider. At 310, the device is operatively connected to a host, via the connection mechanism of FIG. 1, for example. In response to this connection, and in response to the detection of this connection, at 320 the A/V clip is uploaded from the device to the host. At 330, the A/V clip is automatically played on the host.

The various embodiments of the present invention described herein is described in the general context of method steps or processes, which may be implemented in one embodiment by a computer program product, embodied in a computer-readable medium, including computer-executable instructions, such as program code, executed by computers in networked environments. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Software and web implementations of various embodiments of the present invention can be accomplished with standard programming techniques with rule-based logic and other logic to accomplish various database searching steps or processes, correlation steps or processes, comparison steps or processes and decision steps or processes. It should be noted that the words “component” and “module,” as used herein and in the following claims, is intended to encompass implementations using one or more lines of software code, and/or hardware implementations, and/or equipment for receiving manual inputs.

The foregoing description of embodiments of the present invention have been presented for purposes of illustration and description. The foregoing description is not intended to be exhaustive or to limit embodiments of the present invention to the precise form disclosed, and modifications and variations are possible in light of the above teachings or may be acquired from practice of various embodiments of the present invention. The embodiments discussed herein were chosen and described in order to explain the principles and the nature of various embodiments of the present invention and its practical application to enable one skilled in the art to utilize the present invention in various embodiments and with various modifications as are suited to the particular use contemplated.

What is claimed is:

1. A method for providing animated content to a user, comprising:
storing an animated clip of content on a device;
upon operatively connecting the device to a host, uploading the animated clip to the host; and
automatically rendering the content at the host.

2. The method of claim 1, wherein the animated clip includes audio content.

3. The method of claim 1, wherein the animated clip includes video content.

4. The method of claim 1, wherein the animated clip includes audio content and video content.

5. The method of claim 1, wherein the device is operatively connected to the host via a connection mechanism.

6. The method of claim 5, wherein the connection mechanism is selected from the group consisting of a cardbus, an express card, a peripheral component interconnect express mini card, and a wireless local area network connection.

7. The method of claim 1, wherein the device comprises a wireless wide area network device.

8. The method of claim 1, wherein the animated content comprises branding for a service provider.

9. The method of claim 1, wherein the animated content comprises an advertisement.

10. A device, comprising:
a processor; and
a memory unit communicatively connected to the processor and including:
computer code for storing an animated clip of content;
computer code for detecting an operative connection between the device and a host; and
computer code for, upon the detection of the operative connection, uploading the animated clip to the host such that the clip is automatically rendered thereon.

11. The device of claim 10, wherein the animated clip includes audio content.

12. The device of claim 10, wherein the animated clip includes video content.

13. The device of claim 10, wherein the animated clip includes audio content and video content.

14. The device of claim 10, wherein the operative connection with the host occurs via a connection mechanism.

15. The device of claim 14, wherein the connection mechanism is selected from the group consisting of a cardbus, an express card, a peripheral component interconnect express mini card, and a wireless local area network connection.

16. The device of claim 10, wherein the device comprises a wireless wide area network device.

17. The device of claim 10, wherein the animated content comprises branding for a service provider.

18. The device of claim 10, wherein the animated content comprises an advertisement.

19. A device comprising:
a processor; and
a memory unit communicatively connected to the processor, wherein the device is configured to:
store an animated clip of content;
detect an operative connection between the device and a host; and
upon the detection of the operative connection, upload the animated clip to the host such that the clip is automatically rendered thereon.

20. The device of claim 19, wherein the animated clip includes audio content.

21. The device of claim 19, wherein the animated clip includes video content.

22. The device of claim 19, wherein the animated clip includes audio content and video content.

23. The device of claim 19, wherein the operative connection with the host occurs via a connection mechanism.

24. The device of claim 23, wherein the connection mechanism is selected from the group consisting of a cardbus, an express card, a peripheral component interconnect express mini card, and a wireless local area network connection.

25. The device of claim 19, wherein the device comprises a wireless wide area network device.

26. The device of claim 19, wherein the animated content comprises branding for a service provider.

27. The device of claim 19, wherein the animated content comprises an advertisement.
